(19) United States
(12) Patent Application Publication
(10) Pub. No.: US 2011/0103178 A1
(43) Pub. Date: May 5, 2011

(54) APPARATUS FOR CONTROLLING SOLIDS BUILD UP IN A MIXER, UNLOADER OR SIMILAR DEVICE

(76) Inventor: Phillip A. Drennen, Lake Villa, IL (US)

(21) Appl. No.: 12/609,446

(22) Filed: Oct. 30, 2009

(51) Int. Cl. B08B 1/02; B01F 15/00

(52) U.S. Cl. 366/271; 15/89; 15/256.5

(57) ABSTRACT

The apparatus of the present invention comprises a plurality of flexible impact elements for controlling the buildup of solids in a mixer, unloader or similar device. The device for use with the impact elements has at least one shaft and a plurality of rotating elements extending radially from the shaft for moving ash or similar particulate solids. The flexible impact elements communicate with the device as the shaft rotates so as to limit or control the buildup of solids on the rotating elements, thus enabling a more efficient throughput of materials by the device.

### FIELD OF INVENTION

The present invention relates to a system for the improved control and/or avoidance of solids buildup on mixers, unloaders and similar conditioning equipment for the throughput and processing of ash or similar materials. Specifically, the present invention includes the employment of chains or other flexible impact members in working communication with rotating elements (such as pins or paddles) employed in mixers and similar equipment to control or prevent the agglomeration of ash or other viscous materials or materials that undergo a chemical reaction that increases its viscosity. The application of the present invention has particular applicability in the field of ash conditioning, specifically for applications in which the ash or other particulate has a high calcium content that can set up and reduce the effective throughput capacity of the mixer, unloader or similar processing equipment.

### BACKGROUND OF THE INVENTION

There are a variety of industrial applications which require the transport and/or processing of large volumes of material containing solids particulate. For instance, many coal burning facilities require the transport of large volumes of ash and related byproducts as part of the normal process of operation. In order to remove, process and/or transport such materials, it is common to condition such ash or other material with water before removal from its site of use. One reason for such water treatment is the ability to suppress dusting or particle emissions during transport. Thus, there is a need to wet ash or similar materials in certain applications.

Unfortunately, plants that condition ash with water can experience significant problems if the ash contains a high content of calcium compounds. The main causes of high calcium content in ash are high-calcium fuels (e.g., “PRB” or Powder River Basin coal) and/or certain types of emissions control equipment (e.g., dry scrubbers). One of the many problems that can result in the buildup of hydrated calcium-based particulate is the agglomeration and pozzolanic qualities of calcium-based materials, i.e., such particulate clumps together and hardens like cement in the presence of water. In processing equipment for removing such particulate, e.g., mixers and unloaders, the particulate has a tendency not only to clump together, but also to stick to the processing surfaces of the equipment.

In applications with a sufficiently high volume of particulate, the processing of wet ash containing calcium can create such a buildup of hardened material on the processing equipment such that the effective throughput of the equipment may become greatly reduced. Thus, in many current applications handling such ash, it may be necessary to intersperse frequent maintenance cycles to as to manually eliminate any buildup on the processing equipment. For instance, it may become necessary to have a cleaning cycle to eliminate buildup of calcium-laden wet ash as frequently as once per load or batch being processed in the case of processing for wet ash from PRB coal. This additional servicing not only further increases the cost of processing such material, but also further reduces the effective throughput of such processing equipment over time, i.e., in order to account for the labor costs and loss of processing time to deal with such buildup.

Thus, the present state of the art reflects a need for a system which can control or prevent the buildup of wet ash or similar agglomerated, pozzolanic material in processing equipment so as to reduce maintenance costs and increase the effective throughput of such equipment.

### DESCRIPTION OF THE PRIOR ART

A variety of approaches have been tried previously with limited success, and with the creation of separate problems. One such approach is the use of water lances, such as was used in the Kansas Board of Public Utilities' Quindaro Power Station (as described in the Power Engineering International article by Brad Buecker and John Meinders entitled “PRB Coal Switch not a Complete Panacea”). In that article, the authors describe how the chemical composition of PRB ash poses a serious problem in boilers, and the existing Quindaro soot blowers were not totally effective in removing the ash, prompting plant management to install partial arc and selective pattern water lances, manufactured by Diamond Power International. The authors describe how the rotating lances installed at Quindaro spray a concentrated stream of water, at 300 psig, to those water-wall locations most prone to ash and slag buildups. However, such an approach would involve expensive retrofitting, and it would not lend itself to an effective in situ control for solids buildup, given the volume of water necessary. Moreover, such an approach would be impractical on a large and varied surface area (such as the rotating elements of a mixer), and the additional volume of water need to blast any particulate off of a mixer or similar device would be counterproductive, both in terms of the adverse environmental impact (i.e., due to the waste of water) and in terms of adding an unnecessary volume of water to the particulate being processed and transported.

Another approach is shown by way of example in published U.S. Pat. No. 5,389,135 (Mouche et al.). Mouche teaches a method of preventing ash deposition on equipment. Mouche recognizes that the buildup of deposits from numerous types of ash during ash handling is a common problem. Mouche teaches a process for preventing ash deposition comprising adding an effective amount of either a hemicellulose extract or molasses to a phosphonate to form a mixture and introducing an effective amount of the mixture to the equipment to prevent ash deposition. Mouche, however, requires the expensive and experimentally temperamental application of a chemical mixture to the process. The cost for operating (much less installing) such a mixture can run on the order of thousands of dollars per year per piece of operating equipment. Even then, the chemical processing merely retards hardening, rather than preventing buildup, and thus manual buildup removal is still required.

What is needed is simple, cost effective solution for the in situ control of hardened solids buildup on mixers, unloaders and similar equipment.

### DEFINITION OF TERMS

The following terms are used in the claims of the patent as filed and are intended to have their broadest plain and ordinary meaning consistent with the requirements of the law.

“Rotating elements” refer to pin, paddles and similar structures for moving ash or similar particular through a piece of processing equipment. Such elements are typically spaced axially along the length of one or more shafts within the processing equipment and also generally protrude orthogonally from the axis of the shaft.

A “frame” refers to a structure for holding, mounting, containing, enclosing or otherwise supporting a shaft in a piece of processing equipment.

An “overhead support” is a structure which may be integral with or connected to the frame (either directly or indirectly) which is connected to the flexible impact elements in order to place the flexible impact elements in operational contact with the rotating elements and/or solids deposited on the rotating elements.

“Flexible impact elements” refer to chains, cords and similar structures for contacting the rotating elements and/or solids deposited on the rotating elements. Such elements will be supported by the frame and generally will be have a linear or straight axis if stretching or hanging undisturbed, but will have the ability to displace or flex upon contact with a rotating element in situ.

Where alternative meanings are possible, the broadest meaning is intended. All words used in the claims set forth below are intended to be used in the normal, customary usage of grammar and the English language.

### OBJECTS AND SUMMARY OF THE INVENTION

The apparatus of the present invention generally includes a piece of processing equipment including at least one (and preferably more than one) shaft for moving particulate, such as ash. The shaft is supported by a frame, and the shaft has a number of rotating elements (such as pins and/or paddles) which rotate as the shaft is turned in order to enable the processing of the particulate. The frame includes an overhead support which may be integral to or connected to the frame, the overhead support for mounting or otherwise hanging a number of flexible impact members therefrom. The flexible impact members, which are most preferably chains, typically hang and are generally stationary in the absence of in situ contact from the rotating elements or from solids deposited on the rotating elements. However, as the processing equipment operates in moving solids, the shaft will rotate, creating contact between the flexible impact elements and the rotating elements. Such contact will control or reduce solids buildup on the rotating elements, thus maintaining the efficacy of moving particulate through the processing equipment for further transport or processing.

The immediate application of the present invention will be seen in processing ash, such as from the processing ash from burning PRB coal, though those of skill will see that the present invention could be applied to other fields requiring a simple and cost effective mechanical solution for preventing the buildup of hardened solids, for instance in applications where the chemical quality of the solids tends to encourage sticking to processing equipment and hardening in the presence of water.

Thus, it can be seen that one object of the disclosed invention is to provide a cost effective system for reducing the maintenance necessary to reduce or remove solids buildup in mixers, unloaders and the like.

A further object of the present invention is to provide a higher effective quality of mixing and/or throughput of mixers, unloaders and similar processing equipment through the in situ control of solids buildup.

Still another object of the present invention is to provide for the effective removal of PRB coal ash or similar agglomerating, pozzolanic solids in aqueous processing environments.

Yet another object of the present invention is to provide a system for processing PRB coal ash and similar solids without the need for expensive chemical treatments to avoid buildup.

It should be noted that not every embodiment of the claimed invention will accomplish each of the objects of the invention set forth above. In addition, further objects of the invention will become apparent based the summary of the invention, the detailed description of preferred embodiments, and as illustrated in the accompanying drawings. Such objects, features, and advantages of the present invention will become more apparent in light of the following detailed description of a best mode embodiment thereof, and as illustrated in the accompanying drawings.

### BRIEF DESCRIPTION OF THE DRAWINGS

FIG. 1 shows a cross sectional view of a piece of processing equipment using a preferred embodiment of the present invention as seen along the axis of the shaft.

FIG. 2 shows a cross sectional view of a piece of processing equipment using a preferred embodiment of the present invention as seen perpendicular to the axis of the shaft.

### DETAILED DESCRIPTION OF THE INVENTION

Set forth below is a description of what is currently believed to be the preferred embodiment or best examples of the invention claimed. Future and present alternatives and modifications to this preferred embodiment are contemplated. Any alternatives or modifications which make insubstantial changes in function, in purpose, in structure or in result are intended to be covered by the claims in this patent.

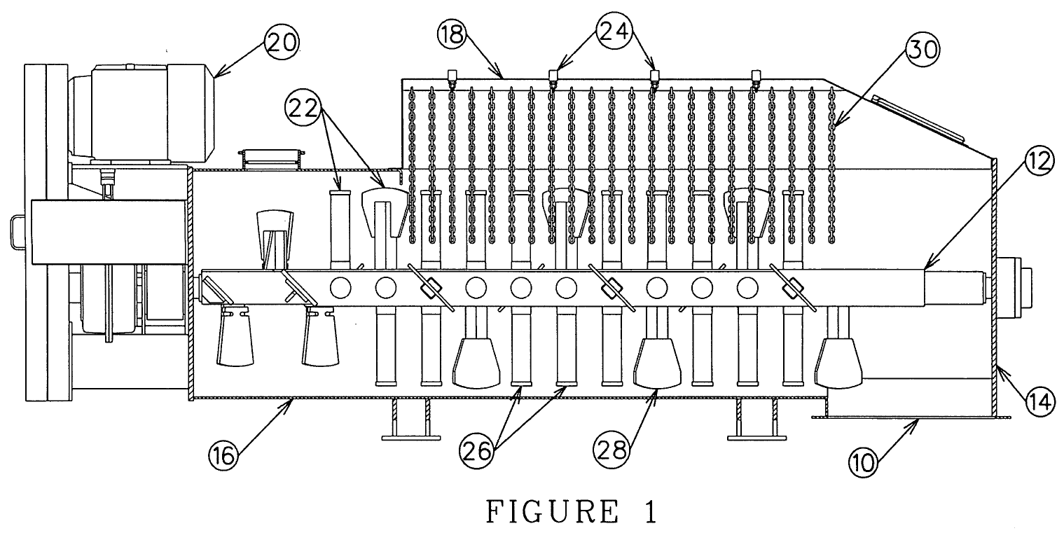

FIG. 1 shows a first preferred embodiment of the present invention as shown in a piece of processing equipment which in this example is mixer/unloader 10. The mixer/unloader 10 comprises a shaft 12, which is supported by a frame 14, which includes a base 16 and an overhead structure or support 18. The base 16 and overhead support 18 may be integrally manufactured or may be directly or indirectly connected to one another. The shaft 12 is rotated by a motor 20 or similar drive mechanism which, when rotated, turn the rotating elements 22 in order to mix the PRB coal ash or other particulate with water which may be provided by spray nozzles 24. The rotating elements 22 most preferably include a combination of pins 26 and paddles 28, though those of ordinary skill in the art will understand that differently configured rotating elements may be used in the practicing of the present invention. One example of an existing commercial embodiment which may be retrofitted or otherwise modified in the practice of the present invention is the United Conveyor Corporation Pin Paddle Mixer/Unloader Model 4050.

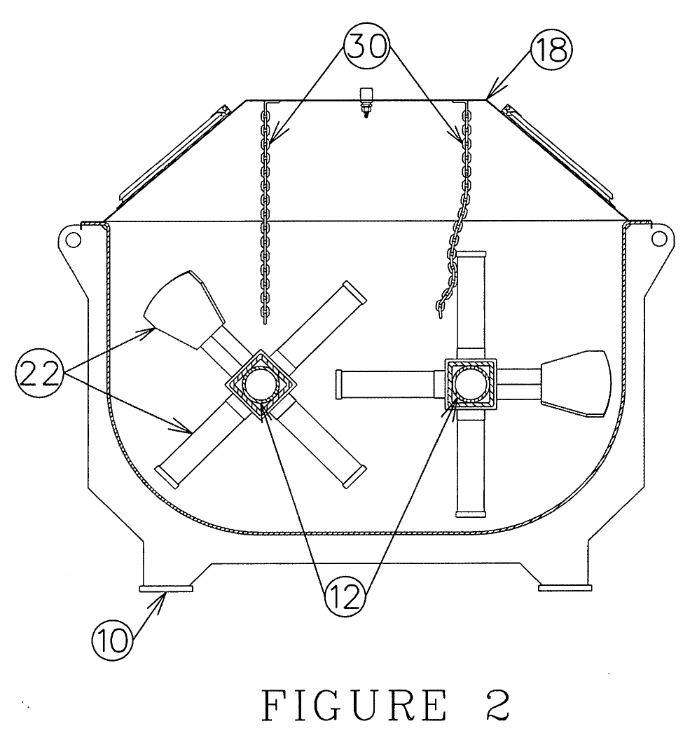

As shown in FIGS. 1 and 2, the present invention also requires the use of a number of flexible impact elements 30. In this preferred embodiment, the flexible impact elements 30 are a series of ½″ chain lengths spaced along the length of the shaft 12, most preferably including a ½″ axial spacing between each chain aligned on a given shaft 12, with each chain hanging from the overhead structure or support 18 via a bracket or other common connector known to those of skill in the art. The most preferred embodiment of the invention will entail an in situ communication between the impact elements 30 and the rotating elements 22. This most preferred embodiment calls for the distal end of the chain (i.e., the one furthest away from support 18) to go no further than ½″ above the bottom or proximal end of the rotating element 22 (i.e., the end of the rotating element 22 connected to shaft 12). In addition, this most preferred embodiment calls for in situ communication between rotating elements 22 and flexible impact elements 30 such that the length of the flexible impact element 30 is at least twice the length of the rotating element 22.

As can be seen in FIG. 2, the present invention can be employed in a piece of processing equipment 10 including two shafts 12. Each shaft 12 in such an embodiment will have its own set of corresponding impact elements 30 displaced along the axis of each respective shaft 12 such that the rotating elements 22 of each shaft 12 will communicate with their respective flexible impact elements 30 so as to prevent the buildup of hardened particulate thereon.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. For instance, the present invention could also work with another preferred embodiment which uses processing equipment including a generally vertical shaft unlike the horizontal shaft embodiments shown in FIGS. 1 and 2. Those of ordinary skill would use the disclosure of the present invention with a vertically extending shaft, for instance, by having flexible impact elements hanging from a support and extending in a direction parallel to the shaft. Likewise, it will be appreciated by those skilled in the art that various changes, additions, omissions, and modifications can be made to the illustrated embodiments without departing from the spirit of the present invention. All such modifications and changes are intended to be covered by the following claims.

What is claimed is:

1. An in situ device for controlling solids buildup upon rotating elements in processing equipment, said processing equipment comprising:
a) A shaft, said shaft having an axial direction along the processing equipment;
b) A frame for supporting said shaft, said frame including an overhead support;
c) A plurality of flexible impact elements, said impact elements connected to said overhead support; and
d) A plurality of rotating elements displaced axially along said shaft, said rotating elements having in situ communication with said flexible impact elements;
Whereby said in situ communication between said impact elements and said rotating elements controls solids buildup upon said rotating elements.

2. The processing equipment of claim 1 further comprising at least a second shaft, said second shaft extending in a parallel direction to said shaft, said second shaft supported by said frame, and said second shaft having a plurality of rotating elements displaced axially along said shaft, said rotating elements of said second shaft having in situ communication with said flexible impact elements.

3. The processing equipment of claim 1 wherein said flexible impact elements comprise chains.

4. The processing equipment of claim 3 wherein said chains extend in a direction generally orthogonal to said shaft.

5. The processing equipment of claim 1 wherein said rotating elements includes a plurality of pins.

6. The processing equipment of claim 1 wherein said rotating elements includes a plurality of paddles.

7. An in situ device for preventing solids buildup upon rotating elements in a mixer, said mixer comprising:
e) A shaft, said shaft having an axial direction along the mixer;
f) A frame for supporting said shaft, said frame including a an overhead support;
g) A plurality of flexible impact elements, said impact elements connected to said overhead support; and
h) A plurality of rotating elements displaced axially along said shaft, said rotating elements having in situ communication with said flexible impact elements;
Whereby said in situ communication between said impact elements and said rotating elements prevents solids buildup upon said rotating elements, thereby reducing the need for manual cleaning cycles to maintain said mixer.

8. The mixer of claim 7 further comprising at least a second shaft, said second shaft extending in a parallel direction to said shaft, said second shaft supported by said frame, and said second shaft having a plurality of rotating elements displaced axially along said shaft, said rotating elements of said second shaft having in situ communication with said flexible impact elements.

9. The mixer of claim 7 wherein said flexible impact elements comprise chains.

10. The mixer of claim 9 wherein said chains extend in a direction generally orthogonal to said shaft.

11. The mixer of claim 7 wherein said rotating elements includes a plurality of pins.

12. The mixer of claim 7 wherein said rotating elements includes a plurality of paddles.

13. An in situ device for improving the throughput of solids processed by rotating elements in a mixer, said mixer comprising:
i) A shaft, said shaft having an axial direction along the mixer;
j) A frame for supporting said shaft, said frame including an overhead support;
k) A plurality of flexible impact elements, said impact elements connected to said overhead support; and
l) A plurality of rotating elements displaced axially along said shaft, said rotating elements having in situ communication with said flexible impact elements;
Whereby said in situ communication between said impact elements and said rotating elements improves the solids throughput for said mixer.

14. The mixer of claim 13 further comprising at least a second shaft, said second shaft extending in a parallel direction to said shaft, said second shaft supported by said frame, and said second shaft having a plurality of rotating elements displaced axially along said shaft, said rotating elements of said second shaft having in situ communication with said flexible impact elements.

15. The mixer of claim 13 wherein said flexible impact elements comprise chains.

16. The mixer of claim 15 wherein said chains extend in a direction generally orthogonal to said shaft.

17. The mixer of claim 13 wherein said rotating elements includes a plurality of pins.

18. The mixer of claim 13 wherein said rotating elements includes a plurality of paddles.

19. The mixer of claim 13, wherein said flexible impact elements are at least twice as long as said rotating elements.

20. The mixer of claim 13, wherein said flexible impact elements are at least approximately ½″ spaced from said shaft.
